(19) United States
(12) Patent Application Publication
(10) Pub. No.: US 2026/0088404 A1
(43) Pub. Date: Mar. 26, 2026

(54) SECONDARY BATTERY INCLUDING PROTECTIVE DEVICE

(71) Applicant: SK On Co., Ltd., Seoul (KR)

(72) Inventors: Ho Jin HWANG, Daejeon (KR); Young Ha KIM, Daejeon (KR); SUNG-HEE MIN, Daejeon (KR); Ga Yeong YOO, Daejeon (KR); Min Jae LEE, Daejeon (KR)

(21) Appl. No.: 19/337,917

(22) Filed: Sep. 24, 2025

(30) Foreign Application Priority Data
Sep. 25, 2024 (KR) 10-2024-0129984

(51) Int. Cl. H01M 50/14; H01M 50/105; H01M 50/178; H01M 50/474

(52) U.S. Cl. CPC H01M 50/14; H01M 50/105; H01M 50/178; H01M 50/474

(57) ABSTRACT

Provided is a secondary battery including a structure for preventing damage to an electrode assembly. The secondary battery may include a pouch exterior material in which an electrode assembly is disposed; and a shock-absorbing pad disposed in a space formed between the pouch exterior material and the electrode assembly and having one end joined to a sealing portion of the pouch exterior material and the other end supporting the electrode assembly.

### CROSS-REFERENCE TO RELATED APPLICATIONS

This application claims priority under 35 U.S.C. § 119 to Korean Patent Application No. 10-2024-0129984, filed on Sep. 25, 2024, in the Korean Intellectual Property Office, the disclosure of which is incorporated herein by reference in its entirety.

### TECHNICAL FIELD

The following disclosure relates to a secondary battery, and more particularly, to a secondary battery including a structure for preventing damage to an electrode assembly.

### BACKGROUND

A secondary battery may be classified into a cylindrical battery in which an electrode assembly is built into a cylindrical metal can, a square battery in which an electrode assembly is built into a square metal can, and a pouch-type battery in which an electrode assembly is built into a pouch-type case of an aluminum laminate sheet, based on a shape of a battery case.

The electrode assembly built into the battery case may be a power element capable of performing charging and discharging, including a stacked structure of a cathode, a separator, and an anode, and may be classified into a jellyroll type, a stack type, and a stack/folding type. The jellyroll type has a separator interposed between a long sheet-shaped cathode and a long sheet-shaped anode coated with an active material and wound; the stack type has a plurality of cathodes and anodes, each having a predetermined size, and sequentially stacked while a separator is interposed between the cathodes and the anodes; and the stack/folding type is a composite structure of the jellyroll type and the stacked type.

In particular, when the electrode assembly described above is built into the pouch-type case, a predetermined gap may be formed between the electrode assembly and the case to form a joint on an exterior material while electrodes protrude outward from the case, and to protect the electrode assembly or to respond to an internal pressure.

However, when a movement of a vehicle equipped with the secondary battery and a resulting inertia are applied, the electrode assembly may move inside the pouch-type case due to the gap between the electrode assembly and the case, which may result in damage to the electrode assembly or the electrodes. In particular, when the arrangement of the gap is designed to be aligned with a travel direction of the vehicle, the damage may be even greater.

### SUMMARY

An embodiment of the present disclosure is directed to providing a secondary battery including a protective device that may minimize a movement of an electrode assembly disposed in a pouch-type case and prevent damage thereto.

An embodiment of the present disclosure is also directed to providing a secondary battery including a protective device that has a flexible structure against internal deformation such as expansion of an electrode assembly.

An embodiment of the present disclosure is also directed to providing a secondary battery including a protective device that may correspond to a surface shape of an electrode assembly.

In one general aspect, a secondary battery includes: an electrode assembly; electrode lead portions protruding from the electrode assembly in one direction or a plurality of directions; a pouch exterior material accommodating the electrode assembly and a portion of the electrode lead portion, allowing the other portion of the electrode lead portion to protrude, and including sealing portions joined to each other along an edge of the electrode assembly to seal an interior of the pouch exterior material; and a shock-absorbing pad disposed between the pouch exterior material and the electrode assembly, and having one end joined to the sealing portions of the pouch exterior material and the other end supporting the electrode assembly.

The shock-absorbing pad may include a contact portion in contact with the electrode assembly, and support portions each connecting the contact portion to a joint.

The support portions may extend from both ends of the contact portion and be connected to the joint, thereby forming a buffer space between the support portions and the contact portion.

The support portions may extend to both ends of the electrode assembly in a thickness direction.

The contact portion may have the same thickness as the electrode assembly.

The shock-absorbing pad may have a support strength that increases from a center toward both ends, with reference to the contact portion.

The shock-absorbing pad may have a thickness that increases from the center toward both the ends, with reference to the contact portion.

The contact portion may have a shape that conforms to a surface shape of the electrode assembly that is in contact with the contact portion.

A width of a joint region where the sealing portions and the joint are in contact with each other may be smaller than a width of the sealing portion.

A length of the joint may be greater than the width of the joint region.

Other features and aspects will be apparent from the following detailed description, the drawings, and the claims.

### BRIEF DESCRIPTION OF THE DRAWINGS

FIG. 1 is a cross-sectional view of a secondary battery including a protective device according to the present disclosure.

FIG. 2 is an enlarged view of the secondary battery including a protective device according to the present disclosure.

FIG. 3 is a cross-sectional view of the secondary battery including a protective device according to the present disclosure.

FIG. 4 is a perspective view of the protective device according to the present disclosure.

FIG. 5 is a side view of the protective device according to the present disclosure.

### DETAILED DESCRIPTION OF EMBODIMENTS

Hereinafter, a technical spirit of the present disclosure is described in more detail with reference to the accompanying drawings. Prior to the description, terms and words used in the specification and claims should not be construed as general or dictionary meanings, and should be construed as meanings and concepts meeting the spirit of the present disclosure based on a principle in which the inventors may appropriately define the concepts of the terms in order to describe their inventions in the best mode. Therefore, configurations described in the embodiments and accompanying drawings of the present disclosure are merely the most preferable embodiments, rather than representing the full scope of the present disclosure. Therefore, the present disclosure should be construed as including all the changes and substitutions included in the spirit and scope of the present disclosure at the time of filing this application.

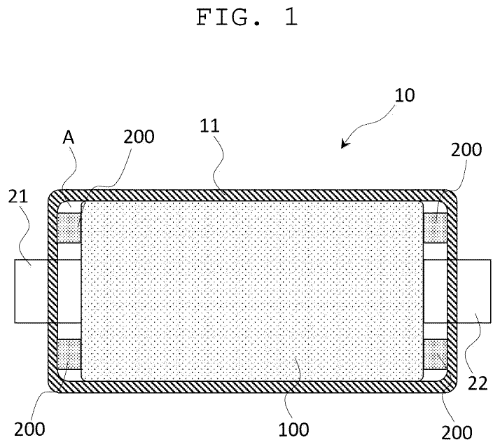

FIG. 1 shows an appearance of a secondary battery according to an embodiment of the present disclosure. As shown in the drawing, a secondary battery 10 may be designed to have a pouch type in which an electrode assembly 100 is disposed within a pouch exterior material 11.

Here, edges of the pouch exterior material 11 may be joined for sealing, and a gap A may be formed between the pouch exterior material 11 and the electrode assembly 100 due to a factor such as a thickness of the electrode assembly 100, an internal pressure design, and connection terminals with electrode lead portions 21 and 22 protruding outward.

According to an embodiment of the present disclosure, the secondary battery may include the shock-absorbing pad 200 as a protective device disposed in the gap A described above. The shock-absorbing pad 200 may fill the gap A by being in contact with each of the pouch exterior material 11 and the electrode assembly 100. For example, a total of four shock-absorbing pads 200 may be arranged on the upper and lower sides of the electrode assembly 100, respectively, at both ends of the electrode assembly 100 where the electrode lead portions 21 and 22 are disposed.

For example, when the secondary battery 10 is mounted in a vehicle, the shock-absorbing pad 200 and the electrode assembly 100 may be disposed in a straight line along a travel direction of the vehicle, considering that the secondary battery 10 is affected by a movement of the vehicle. That is, the shock-absorbing pad 200, the electrode assembly 100, and the shock-absorbing pad 200 may be disposed in that order along the travel direction of the vehicle.

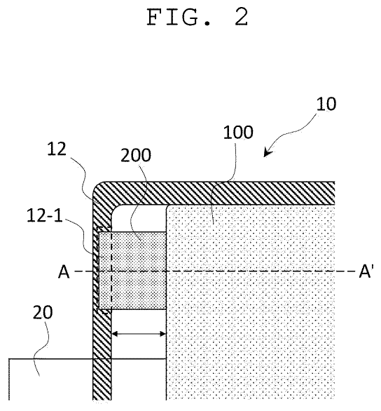

FIG. 2 is an enlarged view of the secondary battery 10 according to an embodiment of the present disclosure. As shown in the drawing, the pouch exterior material 11 may include sealing portions 12 joined to each other along the edge to seal the interior.

For example, the pouch exterior material 11 may be folded so that one exterior material is folded to form a space for accommodating the electrode assembly 100, and three edges are joined to each other, or two exterior materials may be folded to form a space for accommodating the electrode assembly 100, and four edges are joined to each other to form the sealing portions 12.

Here, the electrode assembly 100 may be accommodated inside, the shock-absorbing pad 200 may be disposed in the gap A formed between the electrode assembly 100 and the pouch exterior material 11, and a portion of the shock-absorbing pad 200 may be joined to the sealing portions 12.

For example, a width of a joint region 12-1 may be designed not to exceed a width of the sealing portion 12 to prevent a sealing strength from being reduced or the shock-absorbing pad 200 from protruding outward due to the joint region 12-1 where the shock-absorbing pad 200 and the sealing portions 12 are joined to each other.

That is, the shock-absorbing pad 200 may be designed to be joined to the exterior material constituting the pouch exterior material 11 at the edges, while having the exterior materials joined to each other at an outermost edge.

As a result, the shock-absorbing pad 200 may be fixed to the pouch exterior material 11 to buffer a shock applied to the electrode assembly 100, thereby preventing damage to the electrode assembly 100 itself and protecting electrical components connected to the electrode lead portions 21 and 22.

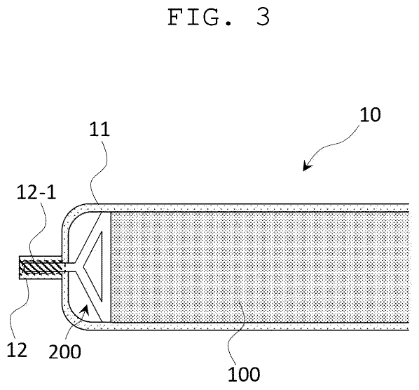

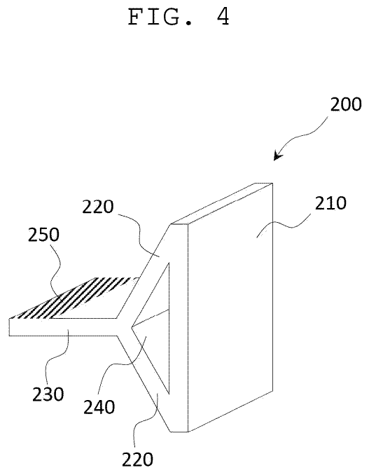

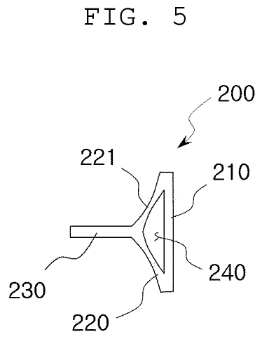

FIG. 3 is a cross-section of the secondary battery according to an embodiment of the present disclosure taken in a direction perpendicular to a surface shown in FIG. 1 or 2; and FIG. 4 and FIG. 5 show a shock-absorbing pad 200 of the secondary battery according to an embodiment of the present disclosure. As shown in the drawing, the shock-absorbing pad 200 may include a joint 230 that is joined to the sealing portions 12, and may be designed to have a shape that becomes wider from the sealing portion 12 toward the electrode assembly 100.

To this end, the shock-absorbing pad 200 may include a contact portion 210 in contact with the electrode assembly 100 and support portions 220 each connecting the contact portion 210 to the joint.

For example, the shock-absorbing pad 200 may include the relatively flat joint 230 that may be interposed between the sealing portions 12, two support portions 220 extending in both directions at a predetermined angle from the joint 230, and the contact portion 210 connected to the two support portions 220 and forming a surface perpendicular to the joint 230.

The contact portion 210, which is in relatively wide contact with the electrode assembly 100, may uniformly alleviate a movement of the electrode assembly 100. To this end, a width of the contact portion 210 may be designed to be the same as the thickness of the electrode assembly 100.

Accordingly, the contact portion 210 and the support portions 220 extending from both ends of the contact portion 210 may form a structure capable of buffering the electrode assembly 100. Further, the structure may have a support strength that increases from a center toward an edge, with reference to the contact portion 210. For example, the structure may have a thickness that increases toward the edge. This structure may respond to barreling or internal pressure caused by expansion of the electrode assembly 100.

Furthermore, in the shock-absorbing pad 200 having such a structure more effective in barreling, internal pressure, or inertia, the support portions 220 may extend from both the ends of the contact portion 210 and be connected to the joint 230, thereby forming a buffer space 240 defined by an angle between the two support portions 220 and the contact portion 210.

Furthermore, a portion of the contact portion 210 may be made of a material that may flexibly change to conform to a surface shape of the electrode assembly 100, considering a case where the electrode assembly 100 has a non-uniform surface.

In addition, as shown in the drawing, the length of the joint 230 may be greater than the length of the joint region 12-1. This configuration is to prevent the support portions 220, which form the predetermined angle in a process of buffering the movement of the electrode assembly 100, from digging into the sealing portion 12 when the joint 230 is assembled to be joined between the sealing portions 12, that is, when the exterior material is joined to both sides of the joint 230.

As set forth above, the secondary battery including a protective device according to the present disclosure may protect the electrode assembly and the connection terminals.

In addition, the secondary battery including protective device according to the present disclosure may suppress the internal movement of the electrode assembly and respond to the deformation, thereby minimizing the damage to the electrode assembly from both the external and internal factors.

In addition, the protective device according to the present disclosure may respond to the non-uniform surface shape of the electrode assembly.

The embodiments of the present disclosure have been described hereinabove with reference to the accompanying drawings. However, it should be understood by those skilled in the art to which the present disclosure pertains that various modifications and alterations may be made without departing from the technical spirit or essential feature of the present disclosure. Therefore, it should be understood that the embodiments described hereinabove are illustrative rather than restrictive in all respects.

What is claimed is:

1. A secondary battery comprising:
an electrode assembly;
electrode lead portions protruding from the electrode assembly in one direction or a plurality of directions;
a pouch exterior material accommodating the electrode assembly and a portion of the electrode lead portion, allowing the other portion of the electrode lead portion to protrude, and including sealing portions joined to each other along an edge of the electrode assembly to seal an interior of the pouch exterior material; and
a shock-absorbing pad disposed between the pouch exterior material and the electrode assembly, and having one end joined to the sealing portions of the pouch exterior material and the other end supporting the electrode assembly.

2. The battery of claim 1, wherein the shock-absorbing pad includes
a contact portion in contact with the electrode assembly, and
support portions each connecting the contact portion to a joint.

3. The battery of claim 2, wherein the support portions extend from both ends of the contact portion and are connected to the joint, thereby forming a buffer space between the support portions and the contact portion.

4. The battery of claim 3, wherein the support portions extend to both ends of the electrode assembly in a thickness direction.

5. The battery of claim 4, wherein the contact portion has the same thickness as the electrode assembly.

6. The battery of claim 5, wherein the shock-absorbing pad has a support strength that increases from a center toward both ends, with reference to the contact portion.

7. The battery of claim 6, wherein the shock-absorbing pad has a thickness that increases from the center toward both the ends, with reference to the contact portion.

8. The battery of claim 5, wherein the contact portion has a shape that conforms to a surface shape of the electrode assembly that is in contact with the contact portion.

9. The battery of claim 2, wherein a width of a joint region where the sealing portions and the joint are in contact with each other is smaller than a width of the sealing portion.

10. The battery of claim 9, wherein a length of the joint is greater than the width of the joint region.
